(19) United States
(12) Patent Application Publication
(10) Pub. No.: US 2023/0307602 A1
(43) Pub. Date: Sep. 28, 2023

(54) NEGATIVE ELECTRODE AND SECONDARY BATTERY INCLUDING THE SAME

(71) Applicant: Prime Planet Energy & Solutions, Inc., Tokyo (JP)

(72) Inventor: Yukitoshi UEHARA, Kobe-shi (JP)

(21) Appl. No.: 18/189,216

(22) Filed: Mar. 24, 2023

(30) Foreign Application Priority Data
Mar. 28, 2022 (JP) 2022-051369

(51) Int. Cl. H01M 4/04; H01M 4/62; H01M 4/583

(52) U.S. Cl. CPC H01M 4/0404; H01M 4/625; H01M 4/622; H01M 4/583; H01M 2004/027

(57) ABSTRACT

Provided is a negative electrode that can reduce a dimensional change of an electrode body in repetitive charge and discharge of a secondary battery and can reduce an internal resistance in performing high-rate discharge on the secondary battery. The negative electrode disclosed here includes a negative electrode current collector, a negative electrode active material layer disposed on the negative electrode current collector, and a coating layer disposed on the negative electrode active material layer. The negative electrode active material layer includes artificial graphite. The coating layer includes natural graphite. A thickness ratio between the coating layer and the negative electrode active material layer is 3:97 to 28:72. Each of the negative electrode active material layer and the coating layer includes a rubber-based binder, and a water-soluble cellulose derivative.

### TECHNICAL FIELD

The present disclosure relates to a negative electrode. The present disclosure also relates to a secondary battery including the negative electrode. This application claims the benefit of priority to Japanese Patent Application No. 2022-051369 filed on Mar. 28, 2022. The entire contents of this application are hereby incorporated herein by reference.

### BACKGROUND

Recent secondary batteries such as lithium ion secondary batteries are suitably used for, for example, portable power supplies for devices such as personal computers and portable terminals, and vehicle driving power supplies for vehicles such as battery electric vehicles (BEVs), hybrid electric vehicles (HEVs), and plug-in hybrid electric vehicles (PHEVs).

As a negative electrode active material of a lithium ion secondary battery, which is a typical secondary battery, graphite has been widely used. Graphite is generally classified into natural graphite and artificial graphite. To utilize properties of each of natural graphite and artificial graphite, Patent Document 1 discloses a negative electrode active material layer having a multilayer structure in which a layer including natural graphite and polyvinylidene fluoride is disposed on a layer including artificial graphite and polyvinylidene fluoride. Patent Document 1 describes that such a negative electrode enhances a charging rate characteristic and reliability of a lithium ion secondary battery.

### CITATION LIST

### Patent Document

Patent Document 1: JP2009-64574A

### SUMMARY OF THE INVENTION

A secondary battery generally uses an electrode body in which a plurality of electrode layers are stacked. Through an intensive study of an inventor of the present disclosure, it has been found that the conventional technique using both natural graphite and artificial graphite described above has the problem of a large dimensional change of the electrode body in repetitive charge and discharge of the secondary battery. In a secondary battery, keeping a constant inter-electrode distance is effective for suppressing characteristic degradation. If the dimensional change of the electrode body is large, a reaction force occurs to the keeping of the inter-electrode distance and can harmfully affect battery characteristics. If the dimensional change of the electrode body is large, the problem of swelling of the battery case also occurs and can harmfully affect the battery module structure and the battery pack structure. The inventor also found that the conventional technique has the problem of a high internal resistance in performing high-rate discharge on the secondary battery.

It is therefore an object of the present disclosure to provide a negative electrode that can reduce a dimensional change of an electrode body in repetitive charge and discharge of a secondary battery and reduce an internal resistance in performing high-rate discharge on the secondary battery.

A negative electrode disclosed here includes: a negative electrode current collector; a negative electrode active material layer disposed on the negative electrode current collector; and a coating layer disposed on the negative electrode active material layer. The negative electrode active material layer includes artificial graphite. The coating layer includes natural graphite. A thickness ratio between the coating layer and the negative electrode active material layer is 3:97 to 28:72. Each of the negative electrode active material layer and the coating layer includes a rubber-based binder, and a water-soluble cellulose derivative. This configuration can provide the negative electrode that can reduce a dimensional change of the electrode body in repetitive charge and discharge of the secondary battery and reduce an internal resistance in performing high-rate discharge on the secondary battery.

In a desired aspect of the negative electrode disclosed here, the rubber-based binder is a styrene-butadiene rubber. In desired aspect of the negative electrode disclosed here, the water-soluble cellulose derivative is carboxymethyl cellulose or a salt thereof. In a desired aspect of the negative electrode disclosed here, a thickness ratio between the coating layer and the negative electrode active material layer is 3:97 to 25:75.

In another aspect, a secondary battery disclosed here includes a positive electrode, the negative electrode described above, and an electrolyte. This configuration can provide the secondary battery showing a small dimensional change of the electrode body in repetitive charge and discharge and a small internal resistance in high-rate discharge.

### BRIEF DESCRIPTION OF THE DRAWINGS

FIG. 1 is a cross-sectional view schematically illustrating a negative electrode according to one embodiment of the present disclosure.

FIG. 2 is a cross-sectional view schematically illustrating an internal structure of a lithium ion secondary battery using a negative electrode according to one embodiment of the present disclosure.

FIG. 3 is a schematic disassembled view illustrating a structure of a wound electrode body of the lithium ion secondary battery illustrated in FIG. 2.

### DETAILED DESCRIPTION OF THE PREFERRED EMBODIMENTS

An embodiment of the present disclosure will be described hereinafter with reference to the drawings. Matters not specifically mentioned herein but required for carrying out the present disclosure can be understood as matters of design of a person skilled in the art based on related art in the field. The present disclosure can be carried out on the basis of the contents disclosed in the description and common general knowledge in the field. In the drawings, members and parts having the same functions are denoted by the same reference characters for description. Dimensional relationships (e.g., length, width, and thickness) in the drawings do not reflect actual dimensional relationships.

A “secondary battery” herein refers to a power storage device capable of being repeatedly charged and discharged, and includes a so-called storage battery and a power storage element such as an electric double layer capacitor. A “lithium ion secondary battery” herein refers to a secondary battery that uses lithium ions as charge carriers and performs charge and discharge by movement of charges accompanying lithium ions between positive and negative electrodes.

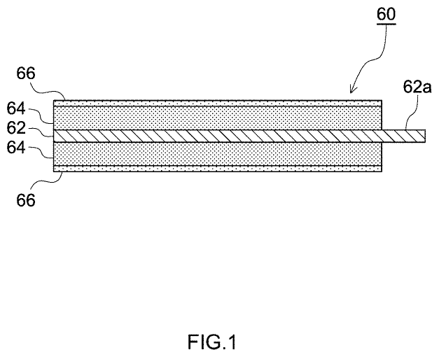

A negative electrode disclosed here is typically used for a secondary battery, and desirably used for a lithium ion secondary battery. FIG. 1 is a cross-sectional view schematically illustrating a negative electrode 60 according to this embodiment as an example of the negative electrode disclosed here, and is a cross-sectional view taken along a thickness direction and a width direction. The negative electrode 60 according to this embodiment illustrated in FIG. 1 is a negative electrode of a lithium ion secondary battery.

As illustrated in FIG. 1, the negative electrode 60 includes a negative electrode current collector 62, a negative electrode active material layer 64, and a coating layer 66. The negative electrode active material layer 64 is formed on the negative electrode current collector 62. The coating layer 66 is formed on the negative electrode active material layer 64. Thus, in the negative electrode 60, the negative electrode active material layer 64 is a layer located on the side of the negative electrode current collector 62, and the coating layer 66 is a layer located on a surface layer portion side. In the illustrated example, the negative electrode active material layer 64 and the coating layer 66 are provided at both principal surfaces of the negative electrode current collector 62, but may be provided only at one principal surface of the negative electrode current collector 62.

In the illustrated example, a negative electrode current collector exposed portion 62a having neither the negative electrode active material layer 64 nor the coating layer 66 is provided at one end of the negative electrode 60 in the width direction. The negative electrode current collector exposed portion 62a can function as a current collector portion. However, the structure for collecting electricity from the negative electrode 60 is not limited to this example.

The negative electrode current collector 62 has a foil shape (or a sheet shape) in the illustrated example, but is not limited to this shape. The negative electrode current collector 62 may have various forms such as a rod shape, a plate shape, or a mesh shape. The material for the negative electrode current collector 62 can be a highly conductive metal (e.g., copper, nickel, titanium, or stainless steel) in a manner similar to a conventional lithium ion secondary battery, and among these metals, copper is desirable. As the negative electrode current collector 62, copper foil is particularly desirable.

Dimensions of the negative electrode current collector 62 are not specifically limited, and may be appropriately determined depending on battery design. In the case of using copper foil as the negative electrode current collector 62, the thickness of the foil is not specifically limited, and is, for example, 5 μm or more and 35 μm or less, and desirably 6 μm or more and 20 μm or less.

The negative electrode active material layer 64 includes a negative electrode active material, a rubber-based binder, and a water-soluble cellulose derivative. In this embodiment, as a negative electrode active material included in the negative electrode active material layer 64, at least artificial graphite is used.

Artificial graphite is graphite produced by performing artificial graphitization on a carbon material, and shows a smaller degree of expansion and contraction during charge and discharge, compared with natural graphite. Thus, artificial graphite contributes to reduction of a dimensional change of the negative electrode active material layer 64 in repetitive charge and discharge, and accordingly, contributes to reduction of a dimensional change of an electrode body of a secondary battery in repetitive charge and discharge.

The type of artificial graphite is not specifically limited. Examples of artificial graphite include coke-based artificial graphite (i.e., materials obtained by performing graphitization on raw coke, green coke, pitch coke, needle coke, petroleum coke, etc.), pitch-based artificial graphite (i.e., materials obtained by performing calcination and then graphitization on pitches such as coal-based pitch and petroleum-based pitch), materials obtained by performing calcination and then graphitization on organic substances such as resin, mesocarbon microbeads, bulk mesophase graphitized substances, and graphitized mesophase pitch carbon fibers. Among these materials, coke-based artificial graphite is desirable.

As compared to natural graphite, artificial graphite generally has a higher ratio (IG/ID) of a peak intensity of a G band (IG) to a peak intensity of a D band (ID) determined by Raman spectroscopy. The ratio (IG/ID) in artificial graphite is, for example, 6.7 or more, desirably 7.3 or more, and more desirably 8.0 or more. The peak intensity (ID) of the D band and the peak intensity (IG) of the G band are obtained as intensities of peaks appearing around 1360 cm⁻¹ and around 1580 cm⁻¹, respectively, in Raman spectroscopy measurement using argon ion laser light.

An average particle size (median diameter D50) of artificial graphite is not specifically limited, and is, for example, 0.1 μm or more and 50 μm or less, desirably 3 μm or more and 30 μm or less, and more desirably 5 μm or 1 more 22 μm or less. It should be noted that the average particle size (median diameter D50) herein refers to a particle size (D50) whose cumulative frequency is 50% by volume in particle size distribution based on volume measured by a laser diffraction scattering method.

A BET specific surface area of artificial graphite is not specifically limited, and is desirably 1.5 m²/g or more.

The negative electrode active material included in the negative electrode active material layer 64 may be only artificial graphite. The negative electrode active material layer 64, however, may further include a negative electrode active material in addition to artificial graphite within a range that does not significantly inhibit the effects of the present disclosure (e.g., less than 10 mass %, less than 5 mass %, less than 3 mass %, or less than 1 mass % of the total mass of the negative electrode active material).

The content of artificial graphite in the negative electrode active material layer 64 is not specifically limited, and is desirably 90 mass % or more, and more desirably 95 mass % or more.

In the conventional technique, polyvinylidene fluoride (PVdF) is used for a binder. Here, PVdF is usually used with an organic solvent in negative electrode mixture slurry (or paste) for forming a negative electrode active material layer, and therefore, is classified as a solvent-based binder.

On the other hand, in this embodiment, a rubber-based binder is used. The rubber-based binder is used in the form of latex, emulsion, or dispersion in which fine particles of rubber are dispersed in water, and therefore, is classified as a water-based binder. The water-based binder is usually used with water in negative electrode mixture slurry (or paste) for forming a negative electrode active material layer. The rubber-based binder does not easily swell by a nonaqueous electrolyte, which contributes to reduction of a dimensional change of an electrode body in repetitive charge and discharge of the secondary battery. This also contributes to reduction of an internal resistance in high-rate discharge of the secondary battery. Examples of the rubber-based binder include a styrene-butadiene rubber (SBR), an acrylonitrile butadiene rubber, and an acrylic rubber. These rubber-based binders encompass modified products thereof. Among the rubber-based binders, an SBR is desirable.

The content of the rubber-based binder in the negative electrode active material layer 64 is not specifically limited, and is desirably 0.1 mass % or more and 8 mass % or less, and more desirably 0.2 mass % or more and 3 mass % or less.

The water-soluble cellulose derivative functions as a thickener and also functions as a binder. The water-soluble cellulose derivative can be used with water in negative electrode mixture slurry (or paste). The water-soluble cellulose derivative does not easily swell by a nonaqueous electrolyte, which contributes to reduction of a dimensional change of the electrode body in repetitive charge and discharge of the secondary battery. This also contributes to reduction of an internal resistance in high-rate discharge of the secondary battery. Examples of the water-soluble cellulose derivative include carboxymethyl cellulose (CMC), a salt thereof, methyl cellulose (MC), and hydroxypropyl methyl cellulose (HPMC). Examples of the salt include alkali metal salts such as a lithium salt and a sodium salt. As the water-soluble cellulose derivative, CMC or a salt thereof (particularly a sodium salt) is desirable.

The content of the water-soluble cellulose derivative in the negative electrode active material layer 64 is not specifically limited, and is desirably 0.3 mass % or more and 3 mass % or less, and more desirably 0.4 mass % or more and 2 mass % or less.

The negative electrode active material layer 64 may further include a conductive agent. Examples of the conductive agent include carbon black such as acetylene black (AB). The content of the conductive agent in the negative electrode active material layer 64 is not specifically limited, and is desirably 0.1 mass % or more and 5 mass % or less, and more desirably 0.3 mass % or more and 3 mass % or less.

The negative electrode active material layer 64 may further include a component not described above within a range that does not significantly hinder advantages of the present disclosure (e.g., less than 10 mass %, less than 5 mass %, less than 3 mass %, or less than 1 mass %).

The coating layer 66 includes natural graphite, a rubber-based binder, and a water-soluble cellulose derivative.

Natural graphite is graphite obtained as a natural mineral, and has a higher acceptability of lithium ions than artificial graphite. The coating layer 66 including natural graphite is disposed in the surface layer portion of the negative electrode 60, so that an internal resistance in high-rate discharge of the secondary battery using the negative electrode 60 can be thereby reduced.

Examples of natural graphite include scaly graphite, massive graphite, and earthy graphite. Natural graphite used here may be subjected to spheroidizing. Among these materials, a spheroidized product of scaly graphite is desirable.

As compared to artificial graphite, natural graphite generally has a lower ratio (IG/ID) of a peak intensity of a G band (IG) to a peak intensity of a D band (ID) determined by Raman spectroscopy. This ratio (IG/ID) in natural graphite is, for example, less than 6.7, desirably 6.0 or less, and more desirably 5.5 or less.

An average particle size (median diameter D50) of natural graphite is not specifically limited, and is, for example, 0.1 μm or more and 50 μm or less, desirably 3 μm or more and 30 μm or less, and more desirably 5 μm or more and 22 μm or less.

A BET specific surface area of natural graphite is not specifically limited, and is desirably 1.5 m²/g or more. Natural graphite generally has a higher BET specific surface area than that of artificial graphite. Thus, the BET specific surface area of natural graphite may be larger than the BET specific surface area of artificial graphite.

The content of natural graphite in the coating layer 66 is not specifically limited, and is desirably 90 mass % or more, and more desirably 95 mass % or more.

Specific contents of the rubber-based binder and the water-soluble cellulose derivative used for the coating layer 66 are the same as those of the rubber-based binder and the water-soluble cellulose derivative used for the negative electrode active material layer 64. The types of the rubber-based binder and the water-soluble cellulose derivative included in the coating layer 66 may be the same as, or different from, those of the rubber-based binder and the water-soluble cellulose derivative included in the negative electrode active material layer 64.

The content of the rubber-based binder in the coating layer 66 is not specifically limited, and is desirably 0.1 mass % or more and 8 mass % or less, and more desirably 0.2 mass % or more and 3 mass % or less. The content of the water-soluble cellulose derivative in the coating layer 66 is not specifically limited, and is desirably 0.3 mass % or more and 3 mass % or less, and more desirably 0.4 mass % or more and 2 mass % or less.

The coating layer 66 may further include a conductive agent. Examples of the conductive agent include carbon black such as acetylene black (AB). The content of the conductive agent in the coating layer 66 is not specifically limited, and is desirably 0.1 mass % or more and 5 mass % or less, and more desirably 0.3 mass % or more and 3 mass % or less.

The coating layer 66 may further include a component not described above within a range that does not significantly hinder advantages of the present disclosure (e.g., less than 10 mass %, less than 5 mass %, less than 3 mass %, or less than 1 mass %).

In this embodiment, the coating layer 66 is a thin layer, and a thickness ratio between the coating layer 66 and the negative electrode active material layer 64 (coating layer 66:negative electrode active material layer 64) is 3:97 to 28:72.

The rubber-based binder, which is a water-based binder, and the water-soluble cellulose derivative are used for the negative electrode active material layer 64 and the coating layer 66, and the thickness ratio between the coating layer 66 and the negative electrode active material layer 64 is set within the range described above, so that a dimensional change of the electrode body in repetitive charge and discharge of the secondary battery can be thereby reduced and an internal resistance in high-rate discharge of the secondary battery can also be thereby reduced. Thus, when the thickness ratio of the coating layer 66 is excessively high beyond the range described above, the dimensional change of the electrode body in repetitive charge and discharge of the secondary battery increases. On the other hand, when the thickness ratio of the coating layer 66 is excessively low below the range described above, the internal resistance in high-rate discharge of the secondary battery increases. The thickness ratio between the coating layer 66 and the negative electrode active material layer 64 (coating layer 66:negative electrode active material layer 64) is desirably 3:97 to 25:75.

The thicknesses of the negative electrode active material layer 64 and the coating layer 66 are not specifically limited as long as the thicknesses satisfy the range of the ratio described above. The total thickness of the negative electrode active material layer 64 and the coating layer 66 per side of the negative electrode current collector 62 is usually 20 μm or more, and desirably 50 μm or more. On the other hand, the total thickness is usually 300 μm or less, and desirably 200 μm or less.

The total weight per unit area of the negative electrode active material layer 64 and the coating layer 66 is not specifically limited. As the total weight per unit area increases, the effects of reducing a dimensional change of the electrode body in repetitive charge and discharge of the secondary battery can be more remarkable. Thus, the total weight per unit area of the negative electrode active material layer 64 and the coating layer 66 is desirably 20 mg/cm² or more.

The negative electrode 60 can be produced in, for example, the following manner. Water-based negative electrode mixture slurry (or paste) including artificial graphite, a rubber-based binder, a water-soluble cellulose derivative, water, and an optional component is prepared. The water-based negative electrode mixture slurry is applied onto a negative electrode current collector and dried, thereby forming a negative electrode active material layer 64. Water-based coating layer slurry (or paste) including natural graphite, a rubber-based binder, a water-soluble cellulose derivative, water, and an optional component is prepared. The water-based coating layer slurry is applied onto the negative electrode active material layer 64 and dried, thereby forming a coating layer. The negative electrode active material layer 64 and the coating layer 66 may be further pressed in order to adjust the thicknesses, the densities, and so forth of the negative electrode active material layer 64 and the coating layer 66. These processes can be performed in accordance with a known method.

In the case of fabricating a secondary battery using the negative electrode 60 according to this embodiment, a dimensional change of the electrode body in repetitive charge and discharge of the secondary battery can be reduced, and thereby, occurrence of a reaction force to keeping of the shape of the electrode body (particularly inter-electrode distance) can be suppressed. As a result, deterioration of various battery characteristics can be suppressed. In addition, in the case of fabricating the secondary battery using the negative electrode 60 according to this embodiment, an internal resistance in high-rate discharge of the secondary battery can be reduced.

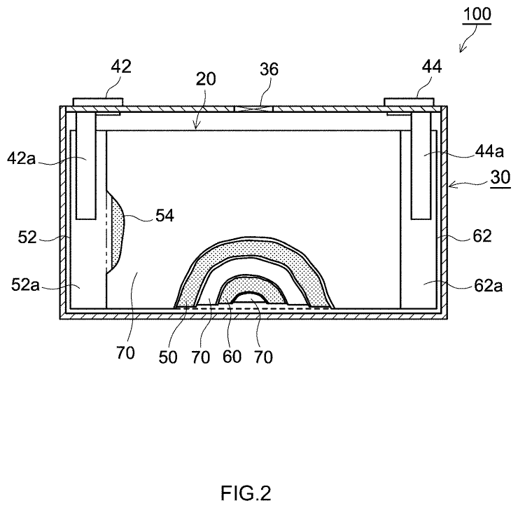

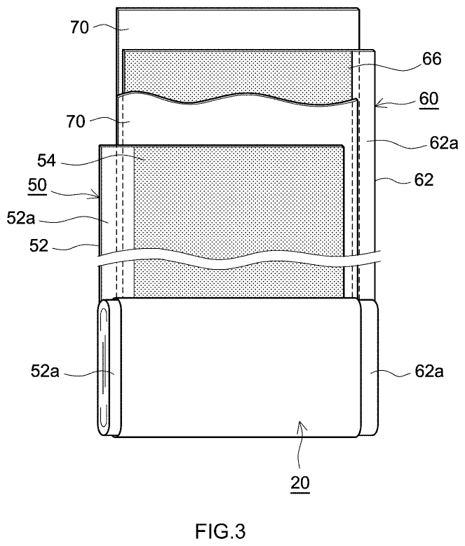

In view of this, in another aspect, a secondary battery disclosed here includes a positive electrode, the negative electrode according to this embodiment, and an electrolyte. An embodiment of the secondary battery disclosed here will be described with reference to FIGS. 2 and 3 using a lithium ion secondary battery as an example.

A lithium ion secondary battery 100 illustrated in FIG. 2 is a sealed lithium ion secondary battery 100 in which a flat wound electrode body 20 and a nonaqueous electrolyte (not shown) are housed in a flat square battery case (i.e., outer container) 30. The battery case 30 includes a positive electrode terminal 42 and a negative electrode terminal 44 for external connection, and a thin safety valve 36 configured such that when the internal pressure of the battery case 30 increases to a predetermined level or more, the safety valve 36 releases the internal pressure. The battery case 30 has an injection port (not shown) for injecting the nonaqueous electrolyte. The positive electrode terminal 42 is electrically connected to a positive electrode current collector plate 42a. The negative electrode terminal 44 is electrically connected to a negative electrode current collector plate 44a. A material for the battery case 30 is, for example, a metal material that is lightweight and has high thermal conductivity, such as aluminium.

As illustrated in FIGS. 2 and 3, in the wound electrode body 20, a positive electrode sheet 50 and a negative electrode sheet 60 are stacked with two long separator sheets 70 interposed therebetween and wound in the longitudinal direction. In the positive electrode sheet 50, a positive electrode active material layer 54 is formed on one or each (each in this example) surface of a long positive electrode current collector 52 along the longitudinal direction. In the negative electrode sheet 60, a negative electrode active material layer 64 is formed on one or each (each in this example) of a long negative electrode current collector 62 along the longitudinal direction, and the coating layer 66 is formed on the negative electrode active material layer 64. The positive electrode current collector exposed portion 52a (i.e., a portion where no positive electrode active material layer 54 is formed and the positive electrode current collector 52 is exposed) and the negative electrode current collector exposed portion 62a (i.e., a portion where none of the negative electrode active material layer 64 and the coating layer 66 is formed and the negative electrode current collector 62 is exposed) extend off outward from both ends of the wound electrode body 20 in the winding axis direction (i.e., sheet width direction orthogonal to the longitudinal direction). The positive electrode current collector plate 42a and the negative electrode current collector plate 44a are respectively coupled to the positive electrode current collector exposed portion 52a and the negative electrode current collector exposed portion 62a.

The number of turns of the wound electrode body 20 is not specifically limited, and is, for example, 20 turns or more and 150 turns or less, and desirably 30 turns or more and 100 turns or less. Thus, in the wound electrode body 20, the number of electrode layers (the sum of positive electrode layers and negative electrode layers) is, for example, 40 or more and 300 or less, and is desirably 60 or more and 200 or less. The same also applies to the number of electrode layers in a case where the electrode body 20 is an electrode body other than the wound electrode body.

The positive electrode current collector 52 constituting the positive electrode sheet 50 may be a known positive electrode current collector for use in a lithium ion secondary battery, and examples of the positive electrode current collector 52 include sheets or foil of highly conductive metals (e.g., aluminium, nickel, titanium, and stainless steel). The positive electrode current collector 52 is desirably aluminium foil.

Dimensions of the positive electrode current collector 52 are not specifically limited, and may be appropriately determined depending on battery design. In the case of using aluminium foil as the positive electrode current collector 52, the thickness thereof is not specifically limited, and is, for example, 5 μm or more and 35 μm or less, and desirably 7 μm or more and 20 μm or less.

The positive electrode active material layer 54 includes a positive electrode active material. The positive electrode active material may be a positive electrode active material having a known composition for use in a lithium ion secondary battery. Specifically, as the positive electrode active material, a lithium composite oxide or a lithium transition metal phosphate compound, for example, may be used. The crystal structure of the positive electrode active material is not specifically limited, and may be, for example, a layered structure, a spinel structure, or an olivine structure.

The lithium composite oxide is desirably a lithium transition metal composite oxide including at least one of Ni, Co, or Mn as a transition metal element, and specific examples of the lithium composite oxide include a lithium nickel composite oxide, a lithium cobalt composite oxide, a lithium manganese composite oxide, a lithium nickel manganese composite oxide, a lithium nickel cobalt manganese composite oxide, a lithium nickel cobalt aluminium composite oxide, and a lithium iron nickel manganese composite oxide. These positive electrode active materials can be used alone or two or more of them may be used in combination.

It should be noted that the “lithium nickel cobalt manganese composite oxide” herein includes not only oxides including Li, Ni, Co, Mn, and O as constituent elements, but also oxides including one or more additive elements besides the foregoing elements. Examples of the additive elements include transition metal elements and typical metal elements, such as Mg, Ca, Al, Ti, V, Cr, Y, Zr, Nb, Mo, Hf, Ta, W, Na, Fe, Zn, and Sn. The additive element may be a metalloid element such as B, C, Si, or P, and a nonmetal element such as S, F, Cl, Br, or I. This also applies in the same manner to, for example, the lithium nickel composite oxide, the lithium cobalt composite oxide, the lithium manganese composite oxide, the lithium nickel manganese composite oxide, the lithium nickel cobalt aluminium composite oxide, and the lithium iron nickel manganese composite oxide.

Examples of the lithium transition metal phosphate compound include lithium iron phosphate (LiFePO₄), lithium manganese phosphate (LiMnPO₄), and lithium manganese iron phosphate.

The positive electrode active material is particularly desirably a lithium nickel cobalt manganese composite oxide.

The average particle size of the positive electrode active material is not specifically limited, and may be substantially equal to an average particle size employed in a conventional lithium ion secondary battery. The average particle size (median diameter D50) of the positive electrode active material is typically 25 μm or less, desirably 1 μm or more and 20 μm or less, and more desirably 3 μm or more and 15 μm or less.

The positive electrode active material layer 54 may include components other than the positive electrode active material, such as trilithium phosphate, a conductive agent, and a binder. Desired examples of the conductive agent include: carbon black such as acetylene black (AB); carbon fibers such as vapor grown carbon fibers (VGCF) and carbon nanotube (CNT); and other carbon materials (e.g., graphite). Examples of the binder include polyvinylidene fluoride (PVdF).

The content of the positive electrode active material in the positive electrode active material layer 54 (i.e., content of the positive electrode active material with respect to the total mass of the positive electrode active material layer 54) is not specifically limited, and is desirably 70 mass % or more, more desirably 80 mass % or more, and much more desirably 85 mass % or more and 99 mass % or less. The content of trilithium phosphate in the positive electrode active material layer 54 is not specifically limited, and is desirably 0.1 mass % or more and 15 mass % or less, and more desirably 0.2 mass % or more and 10 mass % or less. The content of the conductive agent in the positive electrode active material layer 54 is not specifically limited, and is desirably 0.1 mass % or more and 20 mass % or less, and more desirably 0.3 mass % or more and 15 mass % or less. The content of the binder in the positive electrode active material layer 54 is not specifically limited, and is desirably 0.4 mass % or more and 15 mass % or less, and more desirably 0.5 mass % or more and 10 mass % or less.

The thickness of the positive electrode active material layer 54 per side of the positive electrode current collector 52 is not specifically limited, and is typically 20 μm or more, and desirably 50 μm or more. On the other hand, this thickness is typically 300 μm or less, and desirably 200 μm or less.

As the negative electrode sheet 60, the negative electrode 60 described above is used.

Examples of the separator 70 include a porous sheet (film) of a resin such as polyethylene (PE), polypropylene (PP), polyester, cellulose, and polyamide. The porous sheet may have a single-layer structure or a laminated structure of two or more layers (e.g., three-layer structure in which PP layers are stacked on both surfaces of a PE layer). A heat-resistance layer (HRL) may be provided on a surface of the separator 70.

A nonaqueous electrolyte typically includes a nonaqueous solvent and a supporting electrolyte. As the nonaqueous solvent, various organic solvents such as carbonates, ethers, esters, nitriles, sulfones, and lactones for use in an electrolyte of a typical lithium ion secondary battery can be used without any particular limitation. Among these, carbonates are desirable, and specific examples of carbonates include ethylene carbonate (EC), propylene carbonate (PC), diethyl carbonate (DEC), dimethyl carbonate (DMC), ethyl methyl carbonate (EMC), monofluoroethylene carbonate (MFEC), difluoroethylene carbonate (DFEC), monofluoromethyl difluoromethyl carbonate (F-DMC), and trifluorodimethyl carbonate (TFDMC). Such nonaqueous solvents may be used alone or two or more of them may be used in combination.

The supporting electrolyte is desirably lithium salts such as LiPF₆, LiBF₄, and LiClO₄ (desirably LiPF₆), for example. The concentration of the supporting electrolyte is desirably 0.7 mol/L or more and 1.3 mol/L or less.

The nonaqueous electrolyte may include components not described above, for example, various additives exemplified by: a film forming agent such as vinylene carbonate and an oxalato complex; a gas generating agent such as biphenyl (BP) or cyclohexylbenzene (CHB); and a thickener, to the extent that the effects of the present disclosure are not significantly impaired.

The thus-configured lithium ion secondary battery 100 shows a small dimensional change of the electrode body 20 in repetitive charge and discharge and a small internal resistance in high-rate discharge. The lithium ion secondary battery 100 is applicable to various applications. Examples of desired application include a drive power supply to be mounted on a vehicle such as a battery electric vehicle (BEV), a hybrid electric vehicle (HEV), and a plug-in hybrid electric vehicle (PHEV). The lithium ion secondary battery 100 can be used as a storage battery for, for example, a small-size power storage device. The lithium ion secondary battery 100 can be used in a battery pack in which a plurality of batteries are typically connected in series and/or in parallel.

The foregoing description is directed to the square lithium ion secondary battery 100 including the flat wound electrode body 20 as an example. Alternatively, the lithium ion secondary battery can also be configured as a lithium ion secondary battery including a stacked-type electrode body (i.e., electrode body in which a plurality of positive electrodes and a plurality of negative electrodes are alternately stacked). The lithium ion secondary battery can also be configured as a cylindrical lithium ion secondary battery or a laminate-cased lithium ion secondary battery. According to a known method, the lithium ion secondary battery can also be configured as an all-solid-state lithium ion secondary battery using a solid electrolyte instead of a nonaqueous electrolyte.

The negative electrode 60 according to this embodiment is suitable for a negative electrode of a lithium ion secondary battery, and is also usable as negative electrodes of other secondary batteries. These other secondary batteries can be configured in accordance with a known method.

Examples of the present disclosure will now be described, but are not intended to limit the present disclosure to these examples.

### Examples 1 to 5 and Comparative Examples 1 and 2

First, LiNi_{1/3}Co_{1/3}Mn_{1/3}O₂ (LNCM) as a positive electrode active material, acetylene black (AB) as a conductive agent, polyvinylidene fluoride (PVdF) as a binder were mixed at a mass ratio of LNCM:AB:PVdF=97.0:2.0:1.0, and an appropriate amount of N-methyl-2-pyrrolidone (NMP) was added to the resulting mixture, thereby preparing positive electrode mixture slurry. This slurry was applied to both surfaces of aluminium foil as a positive electrode current collector except for lead attachment portions and dried, thereby forming a positive electrode active material layer. This positive electrode active material layer was roll-pressed and cut into a predetermined size, thereby obtaining a positive electrode sheet in which the positive electrode active material layers were formed on both surfaces of the positive electrode current collector. In the resulting positive electrode sheet, the positive electrode active material layer has a packing density of 3.50 g/cm³.

As a negative electrode active material, artificial graphite whose ratio (IG/ID) described above and determined by Raman spectroscopy was 9.1 and BET specific surface area was 1.8 m²/g was prepared. This artificial graphite (AG), AB as a conductive agent, a sodium salt of carboxymethyl cellulose (CMC), and a dispersion of styrene-butadiene rubber (SBR) were mixed at a mass ratio of AG:AB:CMC:SBR (solid content)=96.0:2.0:1.0:1.0, and an appropriate amount of water was added to the resulting mixture, thereby preparing negative electrode mixture slurry. This slurry was applied to both surfaces of copper foil as a negative electrode current collector except for lead attachment portions and dried, thereby forming a negative electrode active material layer. The obtained negative electrode active material layer was cut into a predetermined size.

Natural graphite whose ratio (IG/ID) described above and determined by Raman spectroscopy was 5.5 and BET specific surface area was 2.2 m²/g was prepared. This natural graphite (NG), AB as a conductive agent, a sodium salt of carboxymethyl cellulose (CMC), and a dispersion of styrene-butadiene rubber (SBR) were mixed at a mass ratio of NG:AB:CMC:SBR (solid content)=96.0:2.0:1.0:1.0, and an appropriate amount of water was added to the resulting mixture, thereby preparing a coating layer slurry. This slurry was applied onto the thus-formed negative electrode active material layer and dried, thereby forming a coating layer on the surface of the negative electrode active material layer.

At this time, the application thicknesses of the negative electrode mixture slurry and the coating layer slurry were changed to adjust the thickness ratio between the negative electrode active material layer and the coating layer so as to be the values shown in Table 1. It should be noted that the total thickness of the negative electrode active material layer and the coating layer was uniform among Examples 1 to 5 and Comparative Examples 1 and 2.

The resulting negative electrode active material layer and coating layer were roll-pressed, thereby obtaining a negative electrode sheet in which the negative electrode active material layer and the coating layer were formed on each surface of the negative electrode current collector. In the resulting negative electrode sheet, the negative electrode active material layer had a packing density of 1.50 g/cm³.

A mixed solvent including ethylene carbonate (EC), dimethyl carbonate (DMC), and ethyl methyl carbonate (EMC) at a volume ratio of EC:DMC:EMC=30:40:30 was prepared. Vinylene carbonate was then added to this mixed solvent at a concentration of 1.0 mass %, and LiPF₆ was dissolved at a concentration of 1.15 mol/L. In this manner, a nonaqueous electrolyte was prepared.

As a separator, a porous polypropylene sheet having a single-layer structure was prepared. Leads were attached to the positive electrode sheet and the negative electrode sheet fabricated as described above. The positive electrode sheets and the negative electrode sheets were alternately stacked with separators interposed therebetween, thereby fabricating a stacked-type electrode body. This electrode body was housed in a square battery case together with the nonaqueous electrolyte prepared as described above, and the battery case was hermetically sealed. In this manner, evaluation lithium ion secondary batteries of Examples 1 to 5 and Comparative Examples 1 and 2 were obtained.

### Comparative Example 3

A negative electrode sheet was fabricated in a manner similar to Example 1 except that no coating layer was formed and the thickness of the negative electrode active material layer was equal to the total thickness of the negative electrode active material layer and the coating layer of Example 1. In addition, an evaluation lithium ion secondary battery was fabricated in a manner similar to Example 1 except for using this negative electrode sheet.

### Comparative Example 4

A carbon material mixture in which the artificial graphite (AG) and the natural graphite (NG) described above and a pitch were mixed at a mass ratio of AG:NG=90:10. This carbon material mixture was calcined such that the pitch was carbonized to be amorphous carbon. In this manner, composite graphite in which the surface of artificial graphite was covered with a covering layer including amorphous carbon and natural graphite.

Composite graphite (CG) as a negative electrode active material, AB as a conductive agent, a sodium salt of carboxymethyl cellulose (CMC), and a dispersion of styrene-butadiene rubber (SBR) were mixed at a mass ratio of CG:AB:CMC:SBR (solid content)=96.0:2.0:1.0:1.0, and an appropriate amount of water was added to the resulting mixture, thereby preparing negative electrode mixture slurry. This slurry was applied to both surfaces of copper foil as a negative electrode current collector except for lead attachment portions and dried, thereby forming a negative electrode active material layer. The obtained negative electrode active material layer was cut into a predetermined size.

The resulting negative electrode active material layer was roll-pressed, thereby obtaining a negative electrode sheet in which the negative electrode active material layer was formed on each surface of the negative electrode current collector. In the resulting negative electrode sheet, the negative electrode active material layer had a packing density of 1.50 g/cm³. In Comparative Example 4, the thickness of the negative electrode active material layer was equal to the total thickness of the negative electrode active material layer and the coating layer of Example 1.

An evaluation lithium ion secondary battery was fabricated in a manner similar to Example 1 except for using this negative electrode sheet.

### Comparative Example 5

The artificial graphite (AG) described above, AB as a conductive agent, and polyvinylidene fluoride (PVdF) were mixed at a mass ratio of AG:AB:PVdF=96.0:2.0:2.0, and an appropriate amount of NMP was added to the resulting mixture, thereby preparing negative electrode mixture slurry. This slurry was applied to both surfaces of copper foil as a negative electrode current collector except for lead attachment portions and dried, thereby forming a negative electrode active material layer. The obtained negative electrode active material layer was cut into a predetermined size.

The natural graphite (NG) described above, AB as a conductive agent, and polyvinylidene fluoride (PVdF) were mixed at a mass ratio of NG:AB:PVdF=96.0:2.0:2.0, and an appropriate amount of NMP was added to the resulting mixture, thereby preparing coating layer slurry. This slurry was applied onto the thus-formed negative electrode active material layer and dried, thereby forming a coating layer on the surface of the negative electrode active material layer.

At this time, the application thickness ratio between the negative electrode mixture slurry and the coating layer slurry was 9:1 to thereby adjust the thickness ratio between the negative electrode active material layer and the coating layer so as to be 9:1. The total thickness of the negative electrode active material layer and the coating layer was equal to that in Example 1.

The resulting negative electrode active material layer and coating layer were roll-pressed, thereby obtaining a negative electrode sheet in which the negative electrode active material layer and the coating layer were formed on each surface of the negative electrode current collector. In the resulting negative electrode sheet, the negative electrode active material layer had a packing density of 1.50 g/cm³.

An evaluation lithium ion secondary battery was fabricated in a manner similar to Example 1 except for using this negative electrode sheet.

### Comparative Example 6

The natural graphite (NG) and the artificial graphite (AG) described above were mixed at a mass ratio of NG:AG=10:90, thereby obtaining a graphite mixture. A graphite mixture (GM) as a negative electrode active material, AB as a conductive agent, a sodium salt of carboxymethyl cellulose (CMC), and a dispersion of styrene-butadiene rubber (SBR) were mixed at a mass ratio of GM:AB:CMC:SBR (solid content)=96.0:2.0:1.0:1.0, and an appropriate amount of water was added to the resulting mixture, thereby preparing negative electrode mixture slurry. This slurry was applied to both surfaces of copper foil as a negative electrode current collector except for lead attachment portions and dried, thereby forming a negative electrode active material layer. The obtained negative electrode active material layer was cut into a predetermined size.

The resulting negative electrode active material layer was roll-pressed, thereby obtaining a negative electrode sheet in which the negative electrode active material layer was formed on each surface of the negative electrode current collector. In the resulting negative electrode sheet, the negative electrode active material layer had a packing density of 1.50 g/cm³. In Comparative Example 6, the thickness of the negative electrode active material layer was equal to the total thickness of the negative electrode active material layer and the coating layer of Example 1.

An evaluation lithium ion secondary battery was fabricated in a manner similar to Example 1 except for using this negative electrode sheet.

<Initial Resistance Evaluation in High-Rate Discharge>

Each evaluation lithium ion secondary battery was subjected to constant current, constant voltage charging to have an SOC of 50%. The battery was then placed in a temperature environment of 25° C. and discharged for 10 seconds with a current value of 5 C. A voltage drop value at this time was obtained, and an internal resistance was calculated using this voltage drop value.

<Thickness Change Evaluation after Charge/Discharge Cycle>

Each evaluation lithium ion secondary battery was disassembled in a glove box in an argon atmosphere, and the thickness of the electrode body was measured and defined as an initial thickness. The evaluation lithium ion secondary battery was placed in a temperature environment of 25° C. The evaluation lithium ion secondary battery was subjected to constant current, constant voltage charging up to 4.25 V for three hours with a current value of 0.5 C. Then, the evaluation lithium ion secondary battery was discharged with a constant current to 3.0 V at a current value of 0.5 C. A discharge capacity at this time was obtained, and defined as an initial capacity.

The charge and discharge described above was defined as one cycle, and 1000 cycles of the charge and discharge were performed on each evaluation lithium ion secondary battery. A discharge capacity was obtained in the same manner as described above so that a discharge capacity after 1000 cycles was obtained. From (discharge capacity after 1000 cycles of charge and discharge/initial capacity)×100, a capacity retention rate (%) was obtained.

Then, each evaluation lithium ion secondary battery after 1000 cycles of charge and discharge was disassembled in a glove box in an argon atmosphere, and a thickness of the electrode body after 1000 cycles of charge and discharge was measured. A difference between the thickness of the electrode body after 1000 cycles of charge and discharge and an initial thickness of the electrode body was calculated. Table 1 shows the results.

TABLE 1

| | | | | | | Electrode |
|---|---|---|---|---|---|---|
| | Thickness Ratio | | Negative | | Capacity | Body |
| | Negative Electrode | | Electrode | Initial | Retention | Thickness |
| | Active Material | Coating | Subsidiary | Resistance | Rate | Change |
| | Layer | Layer | Material | (μΩ) | (%) | (μm) |
| Comparative | 50 | 50 | CMC, SBR | 1500 | 79.8 | 630 |
| Example 1 | | | | | | |
| Comparative | 70 | 30 | CMC, SBR | 1502 | 82.4 | 504 |
| Example 2 | | | | | | |
| Example 1 | 72 | 28 | CMC, SBR | 1502 | 82.6 | 370 |
| Example 2 | 75 | 25 | CMC, SBR | 1503 | 82.5 | 366 |
| Example 3 | 80 | 20 | CMC, SBR | 1504 | 82.5 | 368 |
| Example 4 | 9 | 10 | CMC, SBR | 1509 | 82.7 | 366 |
| Example 5 | 97 | 3 | CMC, SBR | 1506 | 83.0 | 364 |
| Comparative | 100 | 0 | CMC, SBR | 1883 | 82.9 | 364 |
| Example 3 | (single layer) | | | | | |
| Comparative | single layer (composited natural | | CMC, SBR | 1509 | 77.3 | 735 |
| Example 4 | graphite and artificial graphite) | | | | | |
| Comparative | 90 | 10 | PVdF | 1696 | 76.4 | 770 |
| Example 5 | | | | | | |
| Comparative | single layer (mixed natural graphite | | CMC, SBR | 1748 | 80.2 | 560 |
| Example 6 | and artificial graphite) | | | | | |

In Comparative Examples 1 to 3 and Examples 1 to 4, the thickness ratio between the negative electrode active material layer and the coating layer was changed. From the results of Table 1, it can be seen that with a small thickness ratio of the coating layer including natural graphite, the influence of natural graphite that easily increases in volume by charge and discharge decreases, and a thickness change of the electrode body after charge and discharge cycles decreases. Furthermore, it can be seen that the thickness ratio of the coating layer and the thickness change of the electrode body do not have a proportional relationship and the thickness change of the electrode body rapidly decreases when the thickness ratio of the coating layer decreases 28% or less.

On the other hand, it can be seen that when no coating layer is provided (Comparative Example 3), an internal resistance in high-rate discharge significantly increases. This suggests that lithium ion acceptability in a negative electrode surface portion is dominant in high-rate discharge. Thus, it can be understood that it is very effective for reduction of the internal resistance in high-rate discharge to provide a coating layer, even a thin coating layer, including natural graphite showing high lithium ion acceptability.

In Comparative Example 4, mixed particles in which artificial graphite was covered with natural graphite was used. A thickness change of the electrode body after charge and discharge cycles was large and a capacity retention rate was low. This is supposed to be because different crystallinity between artificial graphite and natural graphite caused different volume expansion rates, and particle cracks occurred in mixed particles.

In Comparative Example 5, PVdF, which is a solvent-based binder, was used as a binder in a manner similar to a conventional technique. In this case, the thickness change of the electrode body was large, and the internal resistance in high-rate discharge was high. This shows that the effects of reducing the thickness change of the electrode body obtained by a specific thickness ratio between the negative electrode active material layer and the coating layer is significantly exhibited in the case of using a specific binder type.

In Comparative Example 6, artificial graphite and natural graphite were simply mixed. In this case, both suppression of thickness change of the electrode body and reduction of the internal resistance in high-rate discharge were insufficient.

For the foregoing reasons, it can be understood that the negative electrode disclosed here can reduce a dimensional change of the electrode body in repetitive charge and discharge of the secondary battery and can reduce the internal resistance in high-rate discharge of the secondary battery.

Specific examples of the present disclosure have been described in detail hereinbefore, but are merely illustrative examples, and are not intended to limit the scope of claims. The techniques described in claims include various modifications and changes of the above exemplified specific examples.

What is claimed is:

1. A negative electrode comprising:
a negative electrode current collector;
a negative electrode active material layer disposed on the negative electrode current collector; and
a coating layer disposed on the negative electrode active material layer, wherein
the negative electrode active material layer includes artificial graphite,
the coating layer includes natural graphite,
a thickness ratio between the coating layer and the negative electrode active material layer is 3:97 to 28:72,
each of the negative electrode active material layer and the coating layer includes a rubber-based binder, and a water-soluble cellulose derivative.

2. The negative electrode according to claim 1, wherein the rubber-based binder is a styrene-butadiene rubber.

3. The negative electrode according to claim 1, wherein the water-soluble cellulose derivative is carboxymethyl cellulose or a salt thereof.

4. The negative electrode according to claim 1, wherein a thickness ratio between the coating layer and the negative electrode active material layer is 3:97 to 25:75.

5. A secondary battery comprising:
a positive electrode;
the negative electrode according to claim 1; and
an electrolyte.
